(19) United States
(12) Patent Application Publication
(10) Pub. No.: US 2013/0077043 A1
(43) Pub. Date: Mar. 28, 2013

(54) Modular Eye Wear System with Multi-Functional Interchangeable Accessories and Method for System Component Selection, Assembly and Use

(71) Applicant: Sean Thomas Moran, Coos Bay, OR (US)

(72) Inventor: Sean Thomas Moran, Coos Bay, OR (US)

(21) Appl. No.: 13/241,203

(22) Filed: Sep. 23, 2011

(51) Int. Cl. G02C 11/00; G02C 13/00; G02C 5/20; G02C 3/00; G02C 5/14; G02C 5/02

(52) U.S. Cl. 351/118; 351/111; 351/123; 351/178

(57) ABSTRACT

The present invention comprises a universal, modular and multi-functional eye wear system, including a pair of lenses, a pair of temples pivotally connected to the outer part of the lenses, a tail accessory connector connected to the distal end of the temple and an interchangeable multi-functional tail accessory. The universal modular design allows for a multitude of interchangeable options for color, style, prescription, comfort and functionality. The tail accessory connector allows for constrained or unconstrained relative axial rotation between the temple and the tail accessory. The eye wear system gains additional functionality through the integration of a optional bridge connector, or optional wireless communication retention capabilities. This invention has novel and superior functionality, operational flexibility and consumer features over existing products and helps to improve safety of roadways for drivers and pedestrians that use digital communications devices and eye wear.

### BACKGROUND OF THE INVENTION

Eye wear has existed for hundreds of years, yet it continues to prove useful in the everyday lives of people. The general purpose of eye wear is well understood and markets surrounding eye wear are well developed. Eye wear provides many tangible and intangible benefits to wearers, including enhanced vision, shielding from visible and potential harmful ultraviolet light, and even fashion.

Eye wear is typically foldable which creates a compact form for storage while not wearing. Neck bands or straps are commonly used to temporarily hang eye wear from the neck while not in use and to protect them from damage in the event they are dropped. The inconveniences resulting from placement, removal and storage of eye wear continue to cause problems for wearers. This is particularly true when glasses are lost or damaged. While neck bands help to reduce the occurrence of lost or damaged eye wear, additional unique inconveniences are created by them.

Neck bands require the user to fold or lay the eye wear against the chest while not in use. This location is highly inconvenient as it interferes with important working space and work tasks. Glasses lying on the chest are bulky, sway during movement, and create unsightly bulges when placed under clothing. Neck bands are rather difficult to manage as they tangle with buttons, clothing, hair, and other items when removing and replacing the eye wear.

Recent problems include the use of eye wear with the latest technological innovations for communication and digital media. Individuals choosing to wear eye wear concurrently with had phones ear buds and wireless communications devices such as Bluetooth suffer complex device interactions and problems. Users of these technologies often lead busy and active lifestyles that require solutions to demanding problems. Today's consumers of these technologies are connected to streams of information and work continually. These users may need to access media and work while performing any typical task such as driving, walking, exercising or other activities. More importantly, users need to move from activity to activity with continued connectivity to digital information streams. There are no longer clear divisions between work and leisure. The current invention provide unparalleled performance and options for function and style as compared to any previous product.

One recent eye wear innovation developed for market by Clic Eyewear boasts a hard, but semi-elastic integrated neck band and magnetic clasp between the lenses. Although this invention provides for easy removal of the eye wear, it does not solve other existing problems and creates additional new problems. The eye wear continues to create the problem of bulky eye wear lying on the chest. Other problems exist with the neck band of the eye wear. The system is completely unusable if not for the semi-elastic integrated neck band. If the neck band is removed from the design the lens assemblies rotate freely and the eye wear becomes worthless to the user. The eye wear provides no alternative to the hard, unconformable and inflexible neck band. The morphology of the solid neck band is primarily designed for placement while wearing the eye wear. When the eye wear is not being worn, the form of the eye wear is incorrect to match the individual human morphology of the neck to allow for user comfort. Furthermore, the morphology of the neck band is not adjustable or adaptable for individual differences between user morphologies. A recent patent from the original inventor (April 2011) attempts to address this by allowing additional adjustment to the neck band. This is an incremental innovation and does not solve the underlying problems disclosed in this document. The present invention solves these problems, and provides excellent new functionality for users of the future.

Other recent eye wear innovations have been developed by various manufacturers to integrate the functionality of wireless communication devices into the eye wear. Typically these eye wear products are very costly, unstylish, cumbersome or lack flexibility of options. These eye wear typically do not allow use of the wireless communication device separately, or the eye wear separately. One example of this is a recent partnership between Oakley, maker of fashion and performance eye wear, and Motorola, a leading manufacturer of electronic communications devices, such as wireless Bluetooth digital communication devices. The companies simply combined their products together to gain product differentiation over competitors. The above mentioned problems exist for this combined system. Wireless communications devices (i.e., cellular phones, smart phones, wireless headphones, Bluetooth devices, etc.) are often lost, as they are small and frequently moved to new locations (i.e., car, bags, purses, etc.) as people travel. Recent legal developments in the world hold drivers communicating on wireless communications devices accountable for accidents caused by distractions created by using them. Many governments are creating laws that forbid the use of wireless phones while driving unless a wireless communication device, such as a Bluetooth device, is utilized. This trend will continue to grow, which clearly defines the need for solutions to these problems. Drivers need eye wear and wireless communication devices. Google recently purchased Motorola, proving that this market has a significant future for growth and innovation. A real solution to these problems has the potential to save lives and create safer roads. The current eye wear system provides novel, useful, unique and desirable means to solve these problems.

Another form of communication and hearing device commonly used to enjoy music and for communication is the head phone, ear phone or ear bud. These hearing and communication devices are commonly equipped with an integral microphone that enables two-way communication when used with a wireless communication device. Ear phones are retained in the proper location immediately inside the outer ear by the mating and interference between individual physical morphology of the ear and that of the ear phone. Existing products commonly offer various sizes of inserts that allow the user to adapt the device to their individual morphology. Users of these devices commonly live active lifestyle and wear them while exercising with activities such as running, weight training, biking and many other activities. Although there is a recent market trend to offer wireless products that provide stereo functionality, it will take many years before wired devices become obsolete, especially considering that wireless devices require integral batteries to operate. Wired devices are also much less expensive that wireless devices. Wired communication devices have one major disadvantaged. The wire is connected to the media device or wireless earphone. This wire can become tangled on nearly anything, including objects, arms, hands, clothing and many other things. While the user is very active, the wire can also tighten around the body and clothing. All of these incidents can result in pulling or yanking the earphone from the ear. This can also damage the hearing device and has the potential to damage the ear, or earphone, and to distract the user from important tasks, such as driving, crossing a busy street, navigating or other activities. The current eyewear system solves these problems.

### OBJECTIVES OF THE INVENTION

The primary objectives of the present eye wear are to:
Provide a modular eye wear system with multi-faceted options for style and function;
Provide comfortable and concealable eye wear while not wearing and placed on chest;
Provide convenient and functional options for the retention, and integration of wired and wireless digital hearing and communication devices;
To be easily removed and replaced, where eyewear can be worn separately from the accessory and vise versa, when desired;

Additional objectives will become apparent for the present invention upon review of the included figures and detailed description.

### BRIEF SUMMARY OF THE INVENTION

The primary object of the invention is to create a modular and multi-functional eye wear system and methodology for component selection, assembly and use. The invention provides unmatched comfort and novel functionality as compared to any other eye wear. In one form of the invention, when eye wear is not being worn, it quickly converts to lie flush with the chest, which allows for perfect comfort, safe storage and concealment under clothing. Users can select individually preferred color, style, prescription and accessories with unique functionality using this modular eye wear system to create a custom eye wear.

The present eye wear system is comprised of a pair of lenses, a pair of temples connected to the respective outer ends of the lenses, a pair of tail accessory connectors at the distal end of the temples and a variety of available tail accessories. A second embodiment includes a bridge connector connected to the respective inner ends of the lenses. The bridge connector and tail accessory connector can take various forms. The bridge connector can either be present or absent with any particular offering for the product, depending upon whether or not the bridge connector is required to provide the desired functionality for the specific product form. The preferred form of the bridge connector, when used, is a pair of magnetically attracted objects with the form of a polyhedron, where one of the objects is recessed, while the other object is protruding. When mated, the system provides superior functionality, fully constrained relative rotation between the lens assemblies and allows the eye wear to be used with or without a neck band or head band, while allowing for quick and reliable removal and replacement of the eye wear. The nature of this modular, multi-functional and interchangeable eye wear system allows the user a broad array of potential configurations and functionality.

The present eye wear system is different from any other eye wear system ever created. The system allows the user, or manufacturer, to choose components and quickly assemble a custom eye wear system to match their desires for fashion, color, prescription, style and function. Tail accessories are optional as the eye wear functions with or without a neck band or head band. Many options are available for the optional tail accessories, including straight temple extensions, ear hooks, other tail morphologies, semi-rigid neck band, comfort fit or custom neck bands, goggle head bands and others. Other tail accessories include wired and wireless electronic hearing and communication device retainers that are designed specifically to interface with any wireless communication device (i.e., Bluetooth two-way communication devices, ear phones, etc.). A wireless communications device can be integrated into a neck band, or other tail accessory, as is the current state of the art, including current products by Motorola that integrate a wireless communications device with a beck band that is not designed to connect to eye wear. The current invention allows for this functionality by offering a means of connection to eye wear.

The present eye wear system functionality includes the wired and wireless digital communication and hearing devices industry. The present eye wear system is superior to other existing products. The present invention does not claim wireless or wired hearing or communication device technology, but a simple and functional means to integrate any device into the eye wear system through an integral device retainer. A wired or wireless communication or hearing device can be constructed as an integral part of the tail accessory. This might include what is currently called a wireless Bluetooth device or common ear phones. The preferred form is shown in the figures, which consists of a means for connecting any wireless communication device through the mating of a small device retainer. The retainer is designed to mate with the current standard eye wear system, but connects to the wireless communication device as required by the manufacturer. The present eye wear system solves the problem of lost wireless communication devices. Some existing eye wear that include an integrated digital communications device do help to mitigate this problem, but only at the expense of high cost, poor consumer options and an inability to wear the eye wear and communication device separately. The superior performance of the present invention included the functionality that the wireless communication device and eye wear can be worn separately. Any existing equipment from almost any manufacturer can be used with the eye wear system with the unique device retainer. Consumers have shown that this is their preference in the market. The device is simply disconnected from the eyewear, or the integral tail accessory comprising the device retainer is removed from the eye wear and is taken with the user as desired. The user can remove the wireless communication device and leave it behind if their desire is to use only the eye wear. This capability defines yet another feature that proved the superiority of the present invention over other products. The tail accessory can also be constructed to hold other existing electronic communication devices. These devices include existing electronic headphone ear buds. One simple form of a means to accomplish this is shown in the figures. It is comprised of a simple retainer with a socket designed specifically for each manufactures ear phone. The ear phone is simply slid into the socket. This tail accessory holds the ear phones in place while the user wears the eye wear system. This reduces the likelihood that ear buds will be inadvertently pulled from the ears as the accessory prevents relative movement of the ear buds. It accomplishes this by evenly distributing external loading to the eye wear and away from the ear. The load path is diverted to the eye wear, which is supported in position on the user in a multi-point fashion. Both wired and wireless communication devices are compatible with other accessories included in the scope of the present invention. This includes the ability to remove the eye wear and lay it flush with the body. The digital devices retain their important relative anatomical position and when the eye wear is repositioned on the user, the device is already is the correct position. The benefit of eye wear concealment is retained. An additional benefit with various tail accessories is that tail accessory rotation can be enabled as shown in the figures. While the user is wearing the eye wear, the digital hearing device can be rotated out of the ear axially. This allows the user to continue wearing the eye wear and maintain the integration of the digital hearing device, but not be forced to have the device inserted into the ear. When the user desires to use the device, the tail accessory is simple rotated axially by pulling the accessory downward and presses it into the ear. Currently, when the user does not wish to use the hearing device, it must be taken out of the ear. When the user desires to use the device, the user must fumble to find the device and reinsert it into the ear. This is a dangerous and inconvenient distraction. Currently for integrated eyewear and digital hearing devices, when the user does not wish to have the device installed in the ear canal, they must take it out.

The preferred form of the tail accessory connectors is a universal snap-fit joint that enables the use of a modular tail accessory system and allows for precisely constrained, or unconstrained, axial rotational relative motion between the temple and the tail accessories. The preferred form of the tail accessory connectors is comprised of a universal key and keyway integrated into the snap-fit, or interference-fit, connector. This type of connector is well understood in various industries, is subject of expired patents, and is common to various industries, including toys. Tangled Toys, by Tangle Creations is a good example of this type of connector. This connector has been improved upon in one form of the connector, by the current invention. An integral key and keyway system has been integrated into the connector to allow for various levels or rotational constraint between the temple and the tail accessory. The key shape that is integral to the tail accessory is varied to allow precise control of allowable rotation. The keyway integral to the receptacle at the distal end of the temple is universal, so only the tail accessory key must be varied to allow for additional functionality. The modular tail accessory connector allows for any degree of accessory rotation. This function enables diverse functionality of the tail accessory and the eye wear depending upon its configuration and desired function. If no accessory rotation is desired, the key of the tail accessory completely fills the universal keyway of the receptacle. If no rotational constraint is desired, no key is included in the tail accessory. The key/keyway system can be reversed if desired, meaning that the key and be part of the temple and the keyway can be a part of the tail accessory. This document is formulated for simplicity by assuming that the key is part of the tail accessory and that the keyway is part of the temple, as shown in the figures.

Manufacturing materials and processes for eye wear are incredibly varied. Relatively advanced design and manufacturing technologies are utilized in the development of eye wear. The markets are well established, where new products are often either considered to be incremental innovations or seasonal fashion items similar to clothing lines. Performance eye wear systems are somewhat outside of general eye wear markets, where very expensive materials or processes may be used. Eye wear materials utilized today include almost any material used in other manufacturing processes, such as metals, glass, ceramics, plastics and advanced composite materials. Many elements of eye wear are created through molding, plastic injection molding, forging, machining, thermoforming, stamping, multi-process manufacturing, or many other manufacturing processes. Individual elements of eye wear are connected by various means. Most eye wear have some type of pivoting element between the temple and the lens. Often this is in the form of a miniature hinge, or an integrated hinge. Miniature screws are often used to create these connections. The present invention may use any of these materials or processes to create unique eye wear, comprising the novel and useful elements of the disclosed invention.

The functions, claims and relevance of the present invention to the current state-of-the-art is defined in greater detail in the following detailed description of the preferred embodiments in conjunction with the provided drawings.

### BRIEF DESCRIPTION OF THE SEVERAL VIEWS OF THE DRAWING

FIG. 1 is an exploded front perspective view of one embodiment of the present modular eye wear system, specifically illustrating the rectangular polyhedron magnetically connected bridge connector and ear hook tail accessory utilizing the interference-fit tail accessory connector.

FIG. 2 is a front perspective view of one embodiment of the present modular eye wear system, specifically illustrating the rectangular polyhedron magnetically connected bridge connector and ear hook tail accessory utilizing the interference-fit tail connector.

FIG. 3 is a front perspective view of one embodiment of the present modular eye wear system when worn by a person and showing the ear hook tail accessory.

FIG. 4 is a front perspective view of one embodiment of the present modular eye wear system when worn by a person, specifically illustrating the semi-rigid neck band tail accessory with interference-fit plug and receptacle tail accessory connector with ninety degree rotational constraint and polyhedron magnetically connected bridge connector. FIG. 4 shows the combined capability to provide the user with eye wear that lies flush with the body while eye wear is not being worn.

FIG. 5 is a zoomed-in front perspective view of one embodiment of the present modular eye wear system, specifically illustrating the interference-fit plug and receptacle bridge connector.

FIG. 6 is a zoomed-in front perspective view of one embodiment of the present modular eye wear system, specifically illustrating a second embodiment of the interference-fit plug and receptacle bridge connector.

FIG. 7 is a zoomed in front perspective view of one embodiment of the present modular eye wear system, specifically illustrating the polyhedron magnetically connected bridge connector with one magnetically attracted object recessed and the other magnetically attracted object is protruding.

FIG. 8 is a zoomed-in perspective view of one embodiment of the interference-fit plug and receptacle connector with free rotational capability that may be used for the tail accessory connector and/or the optional bridge connector.

FIG. 9 is a zoomed-in perspective view of one embodiment of the interference-fit plug and receptacle connector with variable rotational constraint created by an integral variable angle key and universal keyway, that may be used for the optional bridge connector and/or the tail accessory connector.

FIG. 10 is a zoomed-in perspective view of one embodiment of the a second alternative for the interference-fit plug and receptacle connector that may be used for the bridge connector and/or the tail accessory connector.

FIG. 11 is a perspective view of the straight temple extension tail accessory.

FIG. 12 is a perspective view of the ear catch tail accessory.

FIG. 13 is a perspective view of the flexible goggle head band tail accessory.

FIG. 14 is a perspective view of the neck band tail accessory with widened and/or softened surface for added user comfort.

FIG. 15 is a perspective view of the semi-rigid neck band tail accessory.

FIG. 16 is a perspective view of the semi-rigid neck band tail accessory with an integral wireless communication device retainer and device.

FIG. 17 is a perspective view of the ear catch tail accessory with an integral wireless communication device retainer and device.

FIG. 18 is a perspective view of the ear catch tail accessory with an integral electronic communication device retainer and device in the form of an ear phone prior to full insertion into the retainer.

FIG. 19 is a perspective view of the ear catch tail accessory with an integral electronic communication device retainer and device in the form of an ear phone upon full insertion into the retainer.

FIG. 20 is a perspective view of one embodiment of the eye wear system, specifically illustrating the ear catch tail accessory with an integral wireless communication device retainer and device as worn by a person.

FIG. 21 is a perspective view of one embodiment of the eye wear system, specifically illustrating the ear catch tail accessory with an integral wireless communication retainer and device in the form of an ear phone as worn by a person.

FIG. 22 is an exploded perspective view of one embodiment of the eye wear system, specifically illustrating the stereo communication equipment integral to the tail accessory in the form of a neck band, where said eyewear system can be separated from said tail accessory and worn separately or integrally connected together.

### DRAWING REFERENCE NUMERALS

Lenses (10). Frames (20). Bridge Connectors (30). Temples (40). Interchangeable Tail Accessories (50). Tail Accessory Connectors (60).

### DETAILED DESCRIPTION OF THE INVENTION

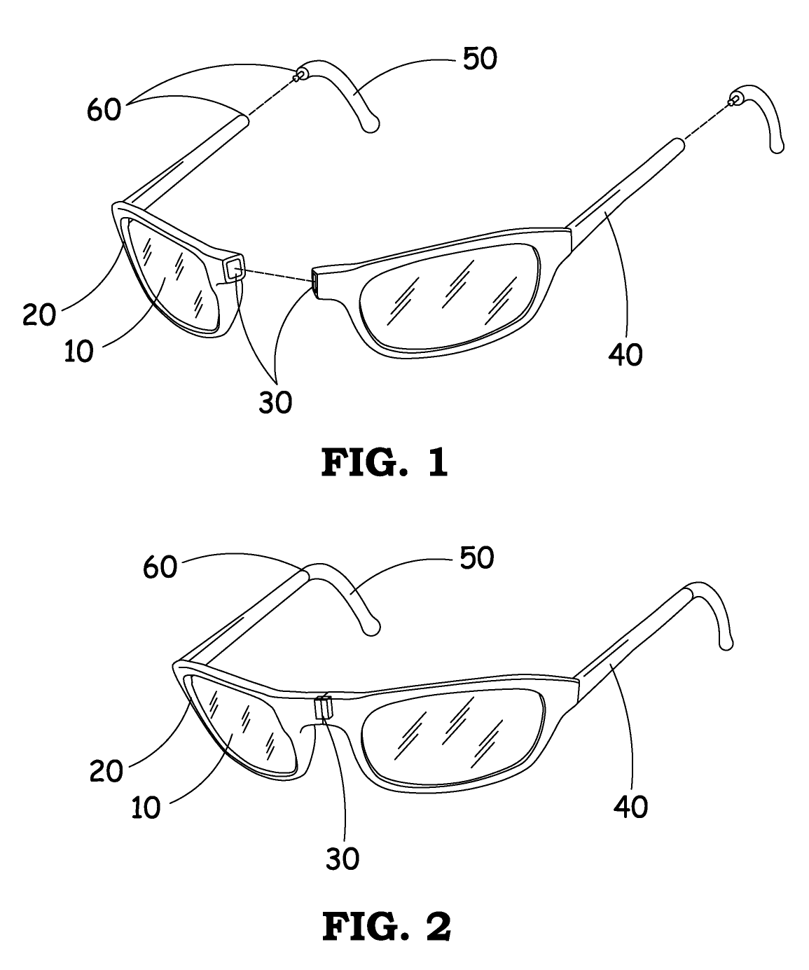

A first embodiment of the present eye wear system is shown in a front perspective view in FIG. 1 and FIG. 2. FIG. 1 shows an exploded view, while FIG. 2 shows a condensed view. The eye wear system shown in this embodiment is comprised of a pair of lenses 10, a bridge connector 30 connected to the respective inner ends of the lenses, a pair of temples 40 connected to the respective outer ends of the lenses, a pair of temple accessory connectors 60 connected between the distal end of the temples and the proximal end of an interchangeable tail accessory 50. A second embodiment does not include the bridge connector 30 as claimed in this disclosure. This eyewear is different than other eye wear as it provides superior modular functionality with or without the use of a neck band.

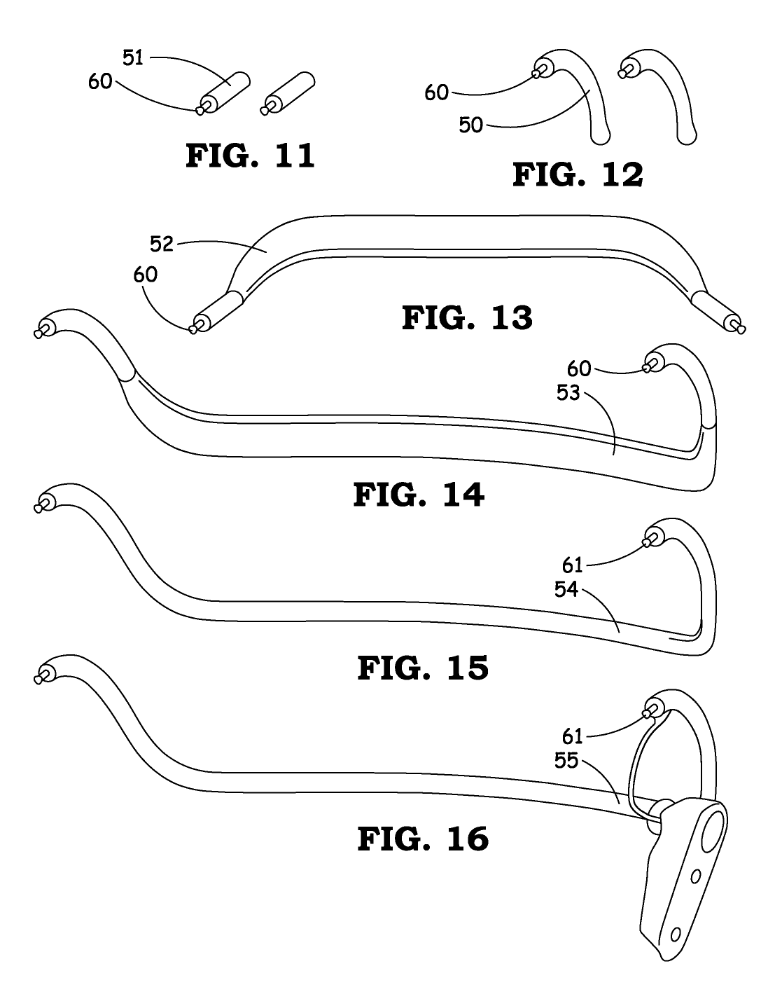

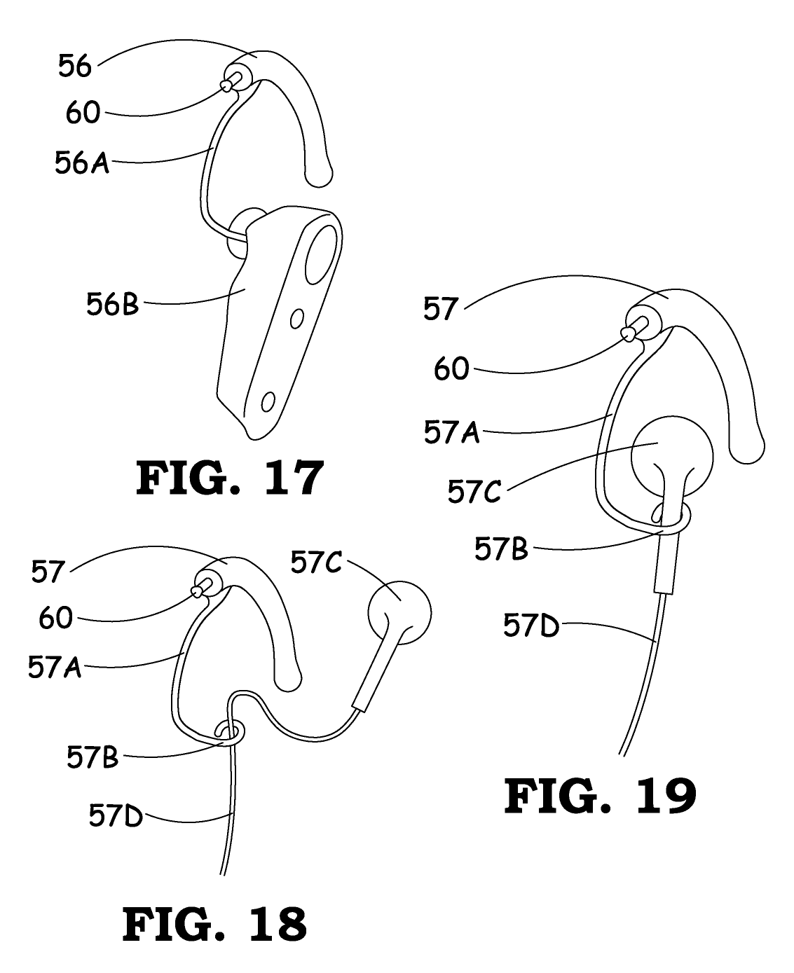

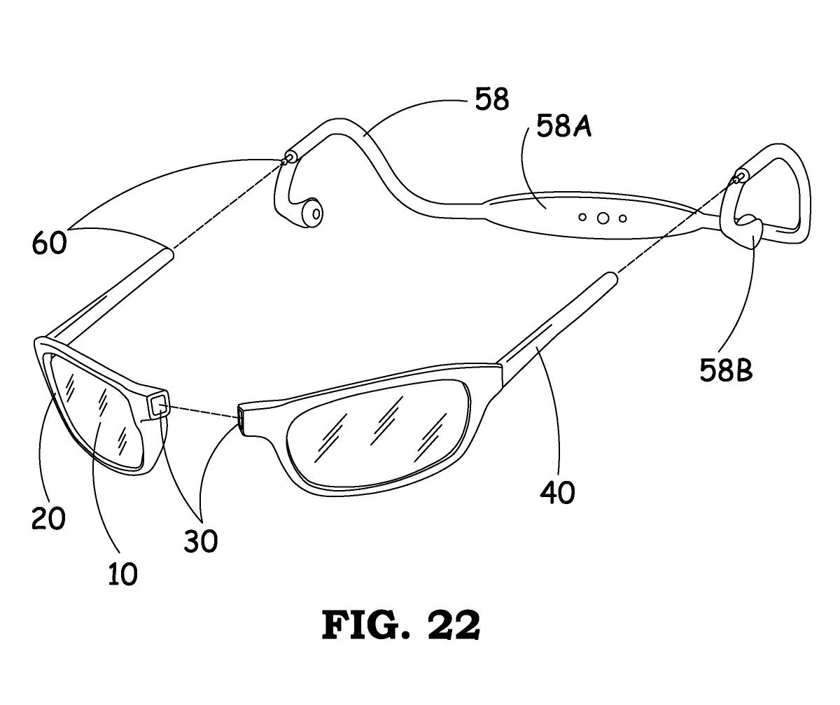

Lenses 10 are preferably mounted in respective frames 20, where the bridge connector 30 is connected to the respective inner ends of frames 20. Temples 40 are preferably telescopic allowing for adjustment to individual physical morphologies of the user, but this is not required. Temples 40 are preferably pivoted to the respective outer ends of frames 20 as is common to most current eye wear. The interchangeable tail accessory 50 provides additional functional features to the present eye wear system and is connected to the temples 40 with a tail accessory connector 60. Many tail accessories 50 can be chosen to match the user's specific desires for form, fashion and/or functionality, some of which are shown in FIG. 11, FIG. 12, FIG. 13, FIG. 14, FIG. 15, FIG. 16, FIG. 17, FIG. 18, FIG. 19 and FIG. 22. These accessories include an ear hook 50, as shown in FIG. 12, a straight temple extension 51, flexible goggle head band 52, semi-rigid comfort neck band 53, semi-rigid neck band 54, neck band with integral digital communication device retainer 55, ear catch with integral digital communication device retainer 56 and ear catch with integral digital communication device retainer 57, specifically showing an ear phone, and head band with integral stereo digital wireless communication device 58. The tail accessory connector 60 allows for relative axial rotational motion between the tail accessory 60 and the temple 40. The bridge connector 30 may be attached directly to the lenses 10 or to the frames 20.

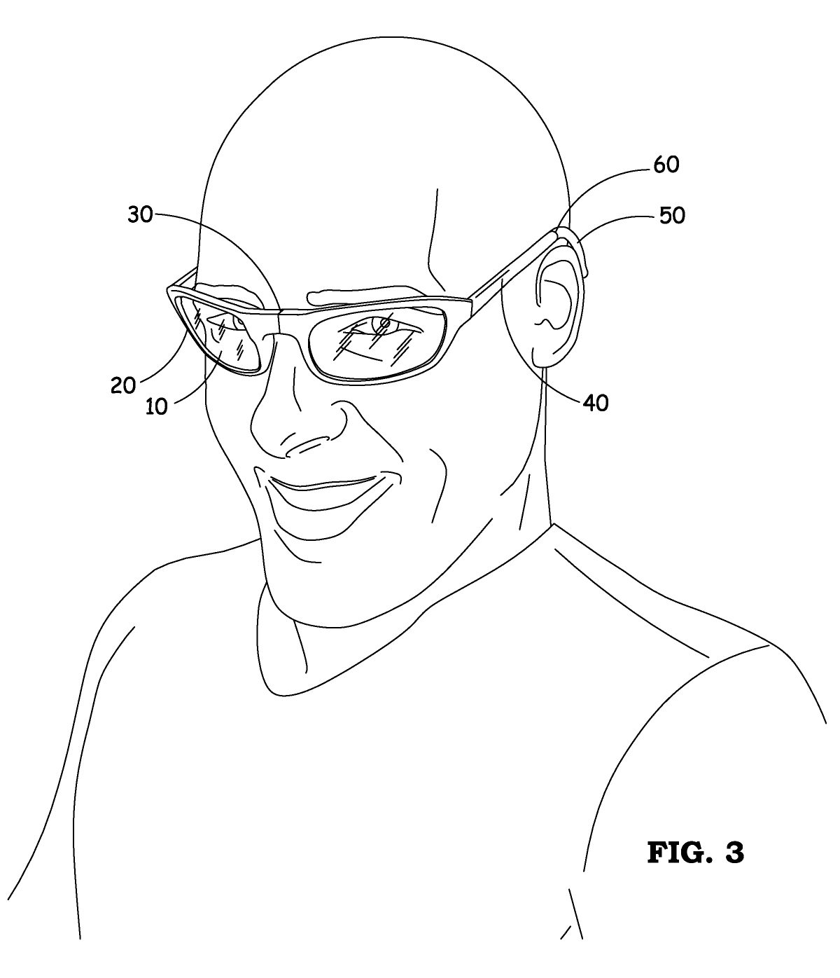

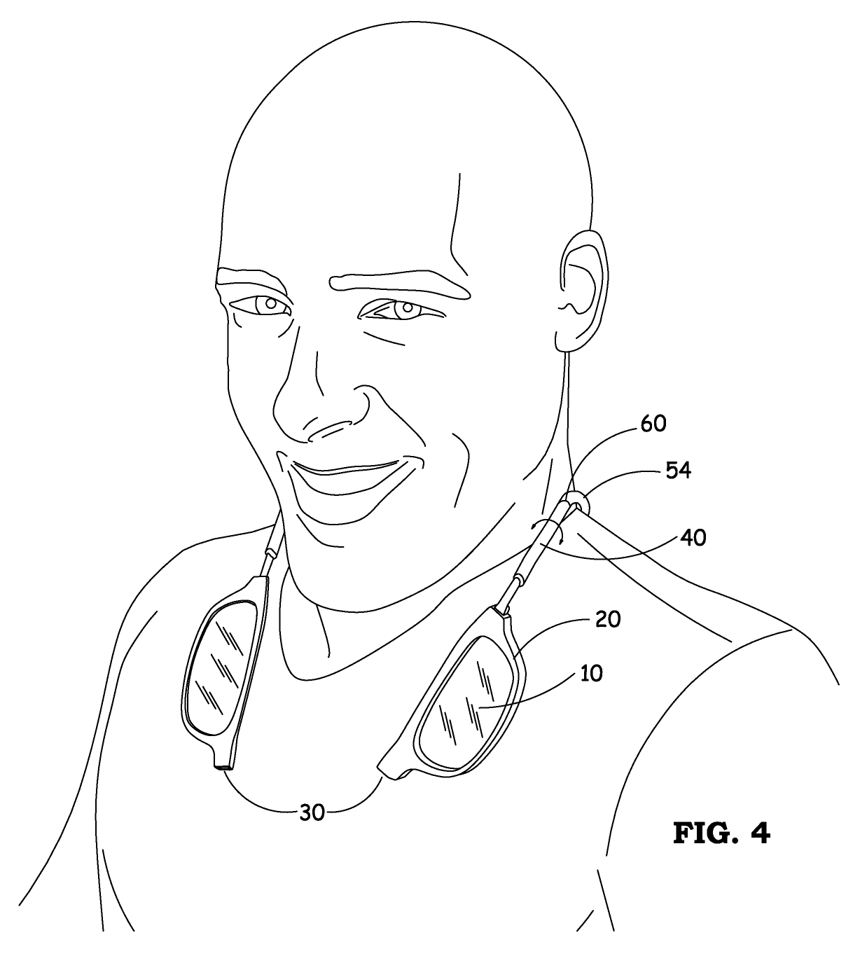

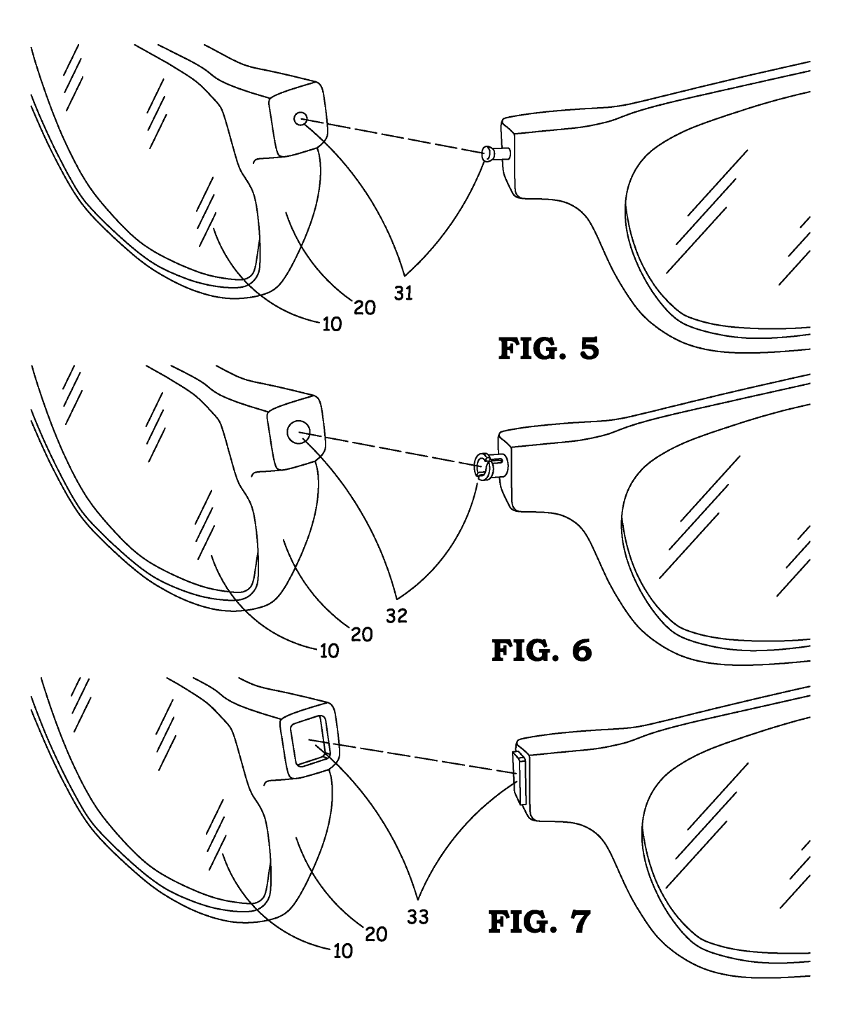

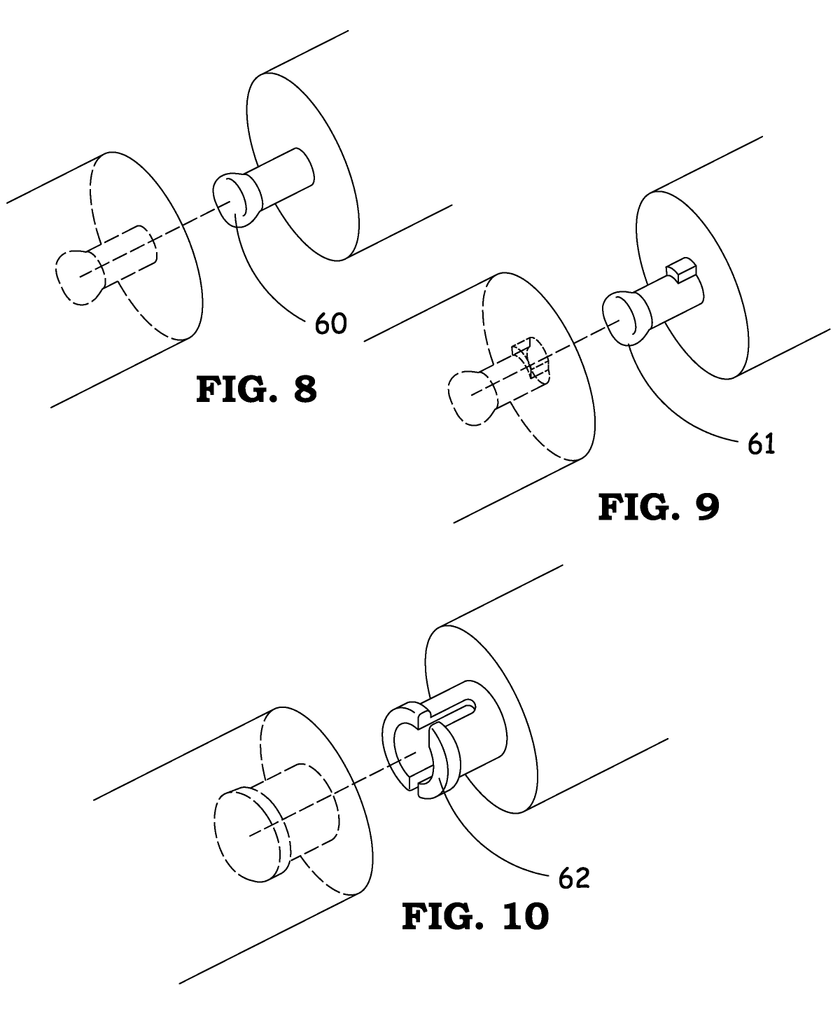

Alternative connectors are disclosed for the bridge connector 30 and the tail accessory connectors 60 in FIG. 5, FIG. 6, FIG. 7, FIG. 8, FIG. 9 and FIG. 10. The bridge connector 30 is preferably comprised of powerful permanent magnetically attracted objects such as those composed of neodymium-iron-boron in the general form of a polyhedron as shown in FIG. 7. This might be comprised of a single magnet on one side and a magnetic ferrous metal on the other side of the bridge connector. The attractive magnetic forces resulting from this form provide for superior resistance to relative rotational motion, which allows for eye wear system to function without a semi-rigid neck band as shown in FIG. 3. Alternative bridge connectors 30 are illustrated in FIG. 5, FIG. 6, FIG. 7, FIG. 8, FIG. 9 and FIG. 10. These include one form of interference-fit plug and receptacle 31 and another form of interference-fit plug and receptacle 32. Interference-fit connections are well understood in mechanical and industrial engineering fields, where elastic and plastic deformation of the material and directly interfering geometries may be utilized to provide a desired and controlled interaction between components. These alternative bridge connectors may be used for the bridge connector 30 or for the tail accessory connector 60 depending upon the desired functionality. The bridge connector 30 is preferably comprised of the bridge connector 33 as shown in FIG. 7. This is an enhancement of the previously disclosed polyhedron magnetically attracted bridge connector 30. This enhancement is comprised of one object of the magnetically attracted pair being recessed into the frame 20 and the opposite mating object of the magnetically attracted pair protruding above the surface of the opposite frame 20. As the magnetically attracted objects are mated, the inner surface of the frame near the recessed object mates with the protruding surfaces of the opposite geometry. This provides superior resistance to relative rotational motion between the opposing lens/frame assemblies. This further allows the usage of the eye wear system without use of a semi-rigid tail accessory, as is the case with the currently available Clic Eyewear. The bridge connector 30 can be comprised of a single magnet with a ferrous metal matching form on the other side as opposed to two mated magnets. The tail accessory connector 60 and tail accessory connector 62 allows for constrained, or unconstrained relative axial rotation between the tail accessory 50 and the temple 40. The tail accessory connector 61 provides variable constrained relative axial rotational capability between the tail accessory 50 and the temple 40. Complete relative rotational constraint is provided by matching the morphology of the universal receptacle keyway and the key of the mating cantilevered connector. Partial relative rotational constraint is provided by reducing the sweep angle of the key of the mating connector as shown in FIG. 9. Precise rotational constraint is easily provided through this mechanism. This capability is useful for various accessories, an example of which is shown in FIG. 4. When the eye wear system is used with the semi-rigid neck band 54 and a ninety degree rotationally constrained tail accessory connector 61, as shown in FIG. 9, the user may rotate the lenses as they are removed and lay them flush against the body. This allows the user of the unworn eye wear system a highly comfortable and unobtrusive option for temporarily storing the eye wear. The eye wear can easily be concealed under clothing until needed. This process is highly ergonomic as it follows the natural rotational movement of the joints in the arms and hands. The process is simply reversed to replace the eyewear in the worn position.

The present eye wear system can be assembled using the method described below. The eye wear assembler first selects individual components meeting their particular desires for their custom eye wear system and combines them by forcing, or snapping them together. The user may choose varying right and left side features, including color, style or prescription. If the user requires a different prescription for each eye as indicated by their ophthalmologist, the user simply selects the proper left or right lens assembly with the proper characteristics, so custom fabrication of eye wear is no longer required. This is much more convenient compared to existing methods which call for the user to order the proper eye wear to be assembled by a specialty eye wear vendor.

The present eye wear system can be positioned on the user through a primary, secondary or tertiary method. The method may be indicated either by user preference, or as indicated by the chosen interchangeable tail accessory 50. The primary method places the eye wear over the top of the head and positions the lenses 10 in front of the eyes and the temples 40 over the ears as shown in FIG. 3. The secondary method separates the bridge connector 30 and places the eye wear from behind the head to the proper position as stated above, where the bridge connector 30 is reconnected. This positioning method is indicated when a neck band or head band is chosen for the tail accessory 50. The tertiary method positions the eye wear as stated above directly from the front as is typical for normal eye wear. This method is indicated when a neck band or head band is not chosen for the tail accessory 50. Again, the eye wear system can be used with or without a neck band or head band with equal effectiveness, creating a highly flexible and functional eye wear system.

The present eye wear system offers novel features for storing the eye wear while not in use. Existing eye wear can typically be stored after rotating the temples inward to create a more condensed form. The eye wear is then typically stored in a separate location such as a pocket, drawer or other location. Eye wear is often damaged or lost due to an accident resulting between the time the eye wear is being worn and when it is being stored. Eye wear can also be hung against the chest with standard lanyards or neck bands, but this is very inconvenient as the eye wear protrudes, is unsightly, swings and often interferes with activities of the user. The present eye wear system allows the user to place the eye wear flush against the chest and even to conceal it underneath clothing with a nearly flat profile, while not in use. This is accomplished as shown in FIG. 4 with a neck band tail accessory as shown in FIG. 13, FIG. 14, FIG. 15, FIG. 16, and FIG. 22. To accomplish this, the bridge connector 30 is separated and the user rotates each temple 40 ninety degrees inward. The lenses are pivoted relative to the temples either outward as shown in FIG. 4, or inward, which creates an even more compact form. This functionality is created through the rotational functionality of the tail accessory connector 60. The eye wear is then laid flush against the chest and can be concealed underneath clothing with an invisible profile. To reposition the eye wear system, the above method is simply reversed. This method actually occurs in one simple, smooth and ergonomic motion. The ergonomic nature of the method makes this an easy to use eye wear system with powerful functionality. This is especially useful for users of reading glasses who must remove and reposition their glasses many times every day.

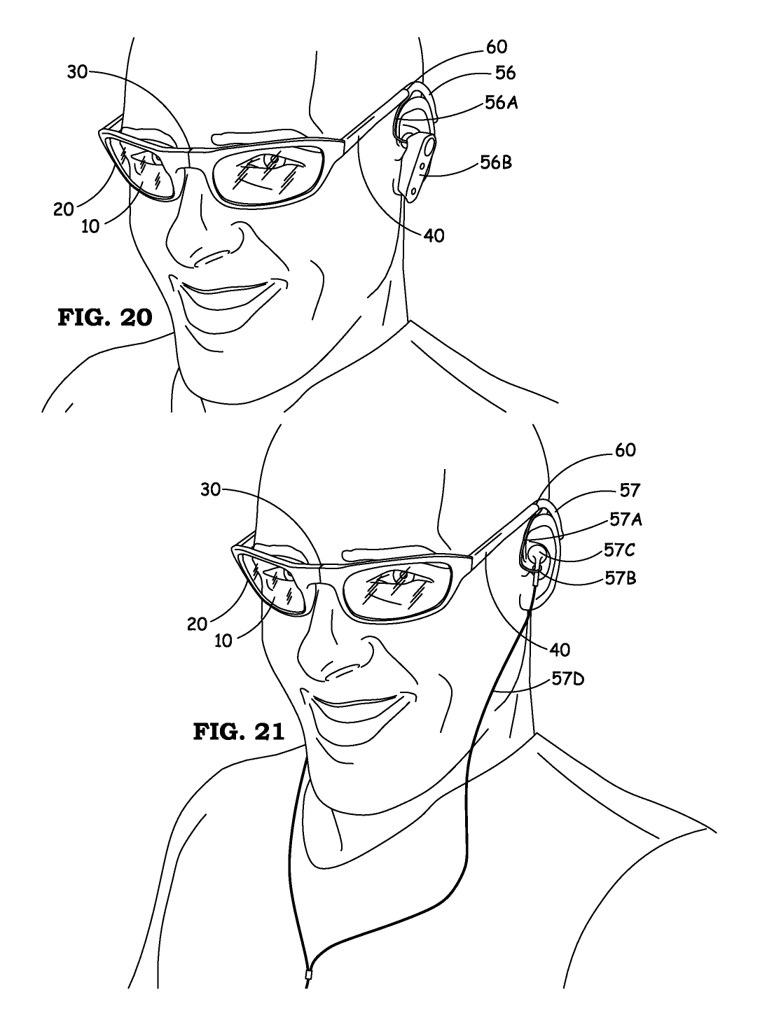

The present eye wear system functionality includes the wired or wireless digital communication and hearing devices industry. The present eye wear system is superior to other existing products as it allows simple integration of these devices with the present eye wear system through simple integration of a retention element to the communication device tail accessories 55, 56, 57, and 58. The wireless device retainer can be added to any tail accessory, including dual devices, which allow for stereo audio functionality. This is the movement of the current market. FIG. 16, FIG. 17, FIG. 18, FIG. 19, and FIG. 22 show how the retention element can retain a wireless communication device. The retainer is very similar to those currently on the market to retain wireless hearing devices (i.e., Bluetooth devices). A very effective and inexpensive form of the retainer is a thin, flexible plastic part designed to interface with the device and curve around the outer ear for device retention. The wireless communication device retainer holds its shape and is generally relatively stiff and elastic. The distal end of the retainer is formed specifically by the device manufacturer to allow for the proper connection. The wireless communication device retention tail accessory is specifically shown as worn by a person in FIG. 20. FIG. 18 and FIG. 19 show how the retention element retains a wired communication device 57C, specifically showing an ear phone 57C. One potential form of the wired communication device retainer 57A holds its shape and is generally relatively stiff and elastic. The distal end of the retainer is formed into an integral cradle 57B, which allows the wire 57D to enter past a small gap in the integral cradle 57B, but not the device itself. The device is then cradled into the proper position and is unable to become loose. The retention element 57B shows how the retention element retains a digital communication device in the form of a head phone. The wired communication device retention tail accessory is specifically shown as worn by a person in FIG. 21. The present invention does not claim wireless or wired hearing or communication device technology, but a simple and functional means to retain any device and integrate any device into the eye wear system. A wired or wireless communication or hearing device retainer can be constructed as an integral part of the tail accessory as shown in FIG. 16, FIG. 17, FIG. 18, FIG. 19 and FIG. 22. FIG. 22 shows a tail accessory with integrated wireless communications technology 58, which is similar to existing products offered by companies such as Motorola. The electronic elements 58A are integrated into the tail accessory and connect internally to the hearing and communications elements 58B of the accessory through the tail accessory.

Digital hearing and communication devices include what is currently called a wireless Bluetooth device or common ear phones. The superior performance of the present invention is that the wireless communication device and eye wear can be worn together, or separately. Consumers have shown that this is their preference in the market. The device is simply disconnected and taken with the user as desired. The user can remove the wireless communication device and leave it behind if their desire is to use only the eye wear. This capability defines the superiority of the present invention over other products. One form of a means to accomplish ear phone retention is shown in the figures. This tail accessory holds the ear phones in place while the user wears the eye wear system. This reduces the likelihood that ear phones will be inadvertently pulled from the ears as the accessory prevents relative movement of the ear phones as the external loading is distributed to the eye wear, away from the ear. The load path is diverted to the eye wear, which is supported in position on the user in a multi-point fashion. Both wired and wireless communication devices are compatible with other accessories included in the scope of the present invention. This includes the ability to remove the eye wear and lay it flush with the body as shown in FIG. 4. The digital devices retain their important relative anatomical position and when the eye wear is repositioned on the user, the device is already is the correct position. The benefit of eye wear concealment is retained.

Manufacturing materials and processes for eye wear are incredibly varied. Relatively advanced design and manufacturing technologies are utilized in the development of eye wear. The markets are well established, where new products are often either considered to be incremental innovations or seasonal fashion items similar to clothing lines. Performance eye wear systems are somewhat outside of general eye wear markets, where very expensive materials or processes may be used. Eye wear materials utilized today include almost any material used in other manufacturing processes, such as metals, glass, ceramics, plastics and advanced composite materials. Many elements of eye wear are created through molding, plastic injection molding, forging, machining, thermoforming, stamping, multi-process, or many other manufacturing processes. Most eye wear have some type of pivoting element between the temples 40 and the lenses 10. Often this is in the form of a miniature hinge, or an integrated hinge between said elements. Miniature screws are often used to create these connections. The present invention may use any of these materials or processes to create unique eye wear, comprising the novel and useful elements of the disclosed invention.

Accordingly, the present eye wear system is easily customizable to desired functionality and style. It is completely stable and secure when worn with or without a neck band or head band if desired by the user. Digital communications devices from any manufacturer can be easily adapted to be used with the current eye wear system and can be used with, or without, the eye wear.

Although the above disclosure is rather specific, it is not considered to limit the scope of the invention, but only as a summary of the functionality of the preferred embodiments. Many variations of functionality and form are possible within the teachings of the invention. Therefore, the scope of the invention is determined by the appended claims and their legal equivalents, not by the limited examples provided.

The present invention has been described in detail specific to the preferred embodiments. The following claims allow for modifications and changes to the preferred embodiments of the present invention.

What is claimed is:

1. An eye wear, comprising:
a. a pair of lenses;
b. an interchangeable tail accessory;
c. a pair of temples connected to respective outer ends of said lenses having means for pivoting between said lenses and said temples; and
d. a pair of tail accessory connectors having means of temporary connection of the distal end of said temples and proximal ends of said interchangeable tail accessory;
e. wherein said interchangeable tail accessory connector allows constrained, or unconstrained, relative axial rotation of said interchangeable tail accessory with respect to said temple;
f. wherein said interchangeable tail accessory has means for providing various useful forms and useful functionality.

2. The eye wear of claim 1, wherein a bridge connector is connected to respective inner ends of said lenses, said bridge connector having means of temporary, dimensionally accurate, stable and secure connection of respective inner ends of said lenses, wherein said bridge connector allows for repeated removal and repositioning of said eye wear.

3. The eye wear of claim 1, wherein said temples are comprised of telescopic temples that allows adjustment to individual user morphology.

4. The eye wear of claim 1, further including a pair of frames that cover all or part of the perimeter of said lenses while holding said lenses, where said frames are attached to one another at respective inner ends and to said temples at respective outer ends.

5. The eye wear of claim 1, wherein said interchangeable tail accessory connector is comprised of an interference-fit plug and receptacle.

6. The eye wear of claim 1, wherein said interchangeable tail accessory is comprised of a semi-rigid, elastic neck band.

7. The eye wear of claim 1, wherein said interchangeable tail accessory is comprised of a flexible neck band.

8. The eye wear of claim 1, wherein said interchangeable tail accessory is comprised of an ear catch.

9. The eye wear of claim 1, wherein said interchangeable tail accessory further includes a wired, or wireless, electronic listening device or electronic communication device retainer, which allows said interchangeable tail accessory to be worn with, or without, remaining elements of said eye wear.

10. The eye wear of claim 1, wherein said interchangeable tail accessory further includes an integral wireless communications device, which allows said interchangeable tail accessory to be worn with, or without, remaining elements of said eye wear.

11. The eye wear of claim 2, wherein said bridge connector is comprised of paired cylindrical magnetically attracted objects.

12. The eye wear of claim 2, wherein said bridge connector is comprised of paired magnetically attracted objects in the general form of a polyhedron, where said polyhedron magnetically attracted objects provide superior axial rotational constraint, allowing said eye wear use with, or without, use of said interchangeable tail accessory, if desired.

13. The eye wear of claim 2, wherein said bridge connector is comprised of paired magnetically attracted objects in the general form of a polyhedron, where one of said polyhedron object is recessed below the surface and the other said polyhedron object protrudes above relative surface thus when said objects are mated said protruding object interferes with recessed surface providing means for superior axial rotational constraint, allowing said eye wear use with, or without, use of said interchangeable tail accessory, if desired.

14. The eye wear of claim 2, further including a pair of frames that cover all or part of the perimeter of said lenses while holding said lenses, where said frames are attached to said bridge connector at respective inner ends and to said temples at respective outer ends.

15. The eye wear of claim 2, wherein said bridge connector is comprised of an interference-fit plug and receptacle with means for axial rotational constraint.

16. The eye wear of claim 2, wherein said interchangeable tail accessory is comprised of a semi-rigid, elastic neck band.

17. The eye wear of claim 2, wherein said interchangeable tail accessory is comprised of a flexible neck band.

18. The eye wear of claim 2, wherein said temples are comprised of telescopic temples that allows adjustment to individual user morphology.

19. The eye wear of claim 2, wherein said interchangeable tail accessory connector is comprised of an interference-fit plug and receptacle.

20. An method for modular eye wear system component selection, assembly and use, comprising:
a. providing an eyewear system of components comprising a pair of lenses, an interchangeable tail accessory, a pair of temples and a pair of tail accessory connectors;
i. a pair of lenses;
ii. an interchangeable tail accessory;
iii. a pair of temples connected to respective outer ends of said lenses having means for pivoting between said lenses and said temples; and
iv. a pair of tail accessory connectors having means of temporary connection of the distal end of said temples and proximal ends of said interchangeable tail accessory;
v. wherein said interchangeable tail accessory connector allows constrained, or unconstrained, relative axial rotation of said interchangeable tail accessory with respect to said temple;
vi. wherein said interchangeable tail accessory has means for providing various useful forms and useful functionality;
vii. selecting said lenses, said temples and said interchangeable tail accessory;
viii. connecting said lenses, said temples and said interchangeable tail accessories using said interchangeable tail accessory connectors;
ix. placing said assembled eyewear system on head of user supported in a multi-point fashion on the bridge of the nose and above each ear.

21. The method of claim 20;
a. wherein a bridge connector is connected to respective inner ends of said lenses, said bridge connector being connected by user;
b. wherein said bridge connector allows for repeated removal and repositioning of said eye wear.

22. Method of claim 20;
a. wherein said interchangeable tail accessory further includes a wired, or wireless, communication device retainer;
b. wherein said wired, or wireless, communication device retainer connects to said interchangeable tail accessory at one end and to a wired, or wireless, communication device at the other end;
c. wherein said wired hearing device retainer maintains the relative position between said interchangeable tail accessory and said wired, or wireless, communication device and further maintains the position of the wired communication device in the inner ear of the user.

23. Method of claim 20;
a. Wherein said interchangeable tail accessory further includes an integral wireless communications device;
b. disconnecting said interchangeable tail accessory from said temple;
c. wearing said interchangeable tail accessory without, said lenses and said temples;
d. wherein said interchangeable tail accessory is easily disconnected and reconnected to said temple and further maintains the position of the said integral wireless communication device in the inner ear of the user.

24. The method of claim 21, including a neck band form for said interchangeable tail accessory;
a. disconnecting said bridge connector of said placed assembled eye wear system;
b. rotating said lenses and said temples with respect to, and as allowed by, said tail accessory connector;
c. placing said lenses and said temples flush with upper torso;
d. wherein eye wear can be easily concealed;
e. wherein eye wear does not interfere with biomechanical work zone;
f. wherein stated process can be easily reversed in an ergonomic fashion to replace the eye wear on the user.

25. The method of claim 22;
a. disconnecting said interchangeable tail accessory from said temple;
b. wearing said interchangeable tail accessory without, said lenses and said temples;
c. wherein said interchangeable tail accessory is easily disconnected and reconnected to said temple and further maintains the position of the said wired, or wireless, wireless communication device in the inner ear of the user.
